(19) United States
(12) Patent Application Publication
(10) Pub. No.: US 2012/0146912 A1
(43) Pub. Date: Jun. 14, 2012

(54) Method for adjusting a display appearance of a keyboard layout displayed on a touch display unit

(75) Inventors: Ta-Chang Chen, Taipei City (TW); Shi Kuan Chen, Taipei City (TW); Ming-Che Weng, Taipei City (TW); Maohu Lai, Taipei City (TW); Bo Chiang Wang, Taipei City (TW)

(73) Assignee: Compal Electronics, INC., Taipei City (TW)

(21) Appl. No.: 13/064,396

(22) Filed: Mar. 23, 2011

(30) Foreign Application Priority Data
Dec. 10, 2010 (TW) 099143221

(51) Int. Cl. G06F 3/02

(52) U.S. Cl. 345/168

(57) ABSTRACT

A method for adjusting a display appearance of a keyboard layout displayed on a touch display unit includes the steps of: (A) detecting a first touch press at a start datum point of the touch display unit; (B) detecting a second touch press at a first position different from the start datum point; (C) detecting a motion track on the touch display unit; (D) computing a key pitch and a key size parameter of the keyboard layout, based on a relative position relationship between the start datum point and the first position; (E) computing a curvature and a curving mode of the keyboard layout, based on a shifting direction and a shifting distance of the motion track; and (F) adjusting a display appearance of the keyboard layout, based on the key pitch, the key size parameter, the curvature, and the curving mode.

### BACKGROUND OF THE INVENTION

1. Field of the Invention

The present invention relates to a method for adjusting a display appearance of a keyboard layout displayed on a touch display unit and, more particularly, to a method for adjusting a display appearance of a keyboard layout displayed on a touch display unit based on different finger lengths, relative positions between the fingers, and habitually operating gestures of each user.

2. Description of Related Art

In recent years, touch panel industries have vigorously developed, and thus it is getting popular to replace a conventional mechanical keyboard with a keyboard layout displayed on a touch display unit (for displaying a virtual keyboard) of a 3C product, such as a tablet personal computer or a mobile phone with a large-size screen. However, the existing method for adjusting the display appearance of a keyboard layout uses a sensor (such as an optical sensor or a pressure sensor) to sense the palm profile of a user in order to proportionally adjust the display appearance of a keyboard layout displayed on a touch display unit. For example, the circumferential size of the keyboard layout and the pitches between the keys are adjusted.

Unfortunately, such a sensing manner has many disadvantages. For example, it is neglected that the palms of a user during typing do not evenly place on the keyboard layout and the fingers are not placed at appropriate positions (i.e., the key arrangement does not meet with ergonomics requirement). Therefore, the hands of a user have various events associated with hand injuries due to the long-term use of poor keyboard medium. Accordingly, it is desirable to provide an improved method which is based on different finger lengths, relative positions between the fingers, and habitually operating gestures on a keyboard to thereby mitigate and/or obviate the aforementioned problems, so that the users can prevent their hands from hand injuries due to the long-term use of keyboard media for inputting data.

### SUMMARY OF THE INVENTION

An object of the present invention is to provide a method for adjusting a display appearance of a keyboard layout, which can adjust a display appearance of a keyboard layout based on different finger lengths, and relative positions between the fingers of each user.

Another object of the present invention is to provide a method for adjusting a display appearance of a keyboard layout, which can adjust a display appearance of a keyboard layout based on habitually operating gestures of each user.

A further object of the present invention is to provide a method for adjusting a display appearance of a keyboard layout, which can adjust display appearances of a plurality of key units on a keyboard based on different finger lengths, and relative positions between the fingers of each user.

To achieve these objects, in the method for adjusting a display appearance of a keyboard layout according to the present invention, the keyboard layout is displayed on a touch display unit and has a plurality of key units. The touch display unit has a start datum point. The method comprises the steps of: (A) detecting a first touch press at the start datum point of the touch display unit; (B) detecting a second touch press at a first position different from the start datum point; (C) detecting a motion track on the touch display unit when the second touch press is dragged from the first position to a second position; (D) computing a key pitch and a key size parameter of the keyboard layout, based on a relative position relationship between the start datum point and the first position; (E) computing a curvature and a curving mode of the keyboard layout, based on a shifting direction and a shifting distance of the motion track; and (F) adjusting a display appearance of the keyboard layout, based on the key pitch, the key size parameter, the curvature, and the curving mode.

To achieve these objects, in the method for adjusting a display appearance of a keyboard layout according to the present invention, the keyboard layout is displayed on a touch display unit and has a plurality of key units. The method comprises the steps of: (A) detecting a touch press respectively at four positions of the touch display unit; (B) computing a key pitch and a key size parameter of the touch display unit based on relative position relationships between the four positions of the touch display unit; and (C) adjusting a display appearance of the keyboard layout based on the key pitch and the key size parameter.

To achieve these objects, in the method for adjusting a display appearance of a keyboard layout according to the present invention, the keyboard layout is displayed on a touch display unit and has a plurality of key units. The touch display unit has a start datum point. Accordingly, the method comprises the steps of: (A) detecting a first touch press at the start datum point of the touch display unit; (B) detecting a second touch press at a first position different from the start datum point; (C) detecting a motion track on the touch display unit when the second touch press is dragged from the first position to a second position; (D) computing a curving mode of the keyboard layout, based on a shifting direction and a shifting distance of the motion track; and (E) adjusting a display appearance of the keyboard layout based on the curving mode.

To achieve these objects, the keyboard with adjustable display appearance according to the present invention comprises: a touch display unit having a plurality of key units; and a processing unit coupled to the touch display unit in order to detect a motion track of hands of a user on the touch display unit, thereby adjusting a display appearance of the key units based on the motion track.

Therefore, the method for adjusting a display appearance of a keyboard layout in the invention can detect both a first touch press and a second touch press on a touch display unit under different fingers of a user. In addition, the method can detect a motion track on the touch display unit in the cases that the finger of the user touches a start datum point (fixing the position of the first touch press) and a second touch press is dragged on the touch display unit from a first position to a second position. In these cases, the method can further compute the parameters, such as “a key pitch”, “a key size parameter”, “a curvature”, and “a curving mode”, required for the keyboard layout. Accordingly, the display appearance can be adjusted in accordance with the finger length, the relative positions between the fingers and the habitually gestures of the keyboard operators such as the size and curvature form of the keyboard displayed on the touch display unit.

Further, the method for adjusting a display appearance of a keyboard layout in the invention can detect four fingers of a user, which touches on a touch display unit, and generate four touch presses corresponding to the four fingers. In this case, the method can compute the parameters of “key pitch” and “key size parameter” required for the keyboard layout. Thus, the method can refer to different finger lengths, relative positions between the fingers, and habitually gestures of operators and adjust a display appearance of the keyboard layout on a touch display unit, such as the size of the keyboard layout.

Furthermore, the method for adjusting a display appearance of a keyboard layout in the invention can detect both a first touch press and a second touch press on a touch display unit under different fingers of a user, detect a motion track on the touch display unit in the cases that a finger of the user touches a start datum point (fixing the position of the first touch press) and a second touch press is dragged on the touch display unit from a first position to a second position. In these cases, the method according to the present invention can compute the parameters, such as “key pitch”, “key size parameter”, “curvature”, and “curving mode”, required for the keyboard layout, in accordance with the motion track detected by the processing unit. Therefore, the method according to the present invention can substantially adjust the display appearances of key units on the touch display unit.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a method for adjusting a display appearance of a keyboard layout according to an embodiment of the invention;

FIG. 2 is a schematic view of a computer having a touch display unit implemented with a method for adjusting a display appearance of a keyboard layout according to an embodiment of the invention;

FIG. 3A is a schematic operation of using the index and middle fingers of the right hand of a user to press on the touch display unit shown in FIG. 2 according to an embodiment of the invention;

FIG. 3B is a schematic operation of using the middle finger of the right hand of a user to move onto the touch display unit shown in FIG. 2 according to an embodiment of the invention;

FIG. 4 is a flowchart of a method for adjusting a display appearance of a keyboard layout according to another embodiment of the invention;

FIG. 5 is a schematic operation of using the index, middle, ring, and little fingers of the right hand of a user to press on the touch display unit shown in FIG. 2 according to another embodiment of the invention;

FIG. 6 is a flowchart of a method for adjusting a display appearance of a keyboard layout according to another embodiment of the invention; and

FIG. 7 is a schematic view of a keyboard with adjustable display appearance according to another embodiment of the invention.

### DETAILED DESCRIPTION OF THE PREFERRED EMBODIMENT

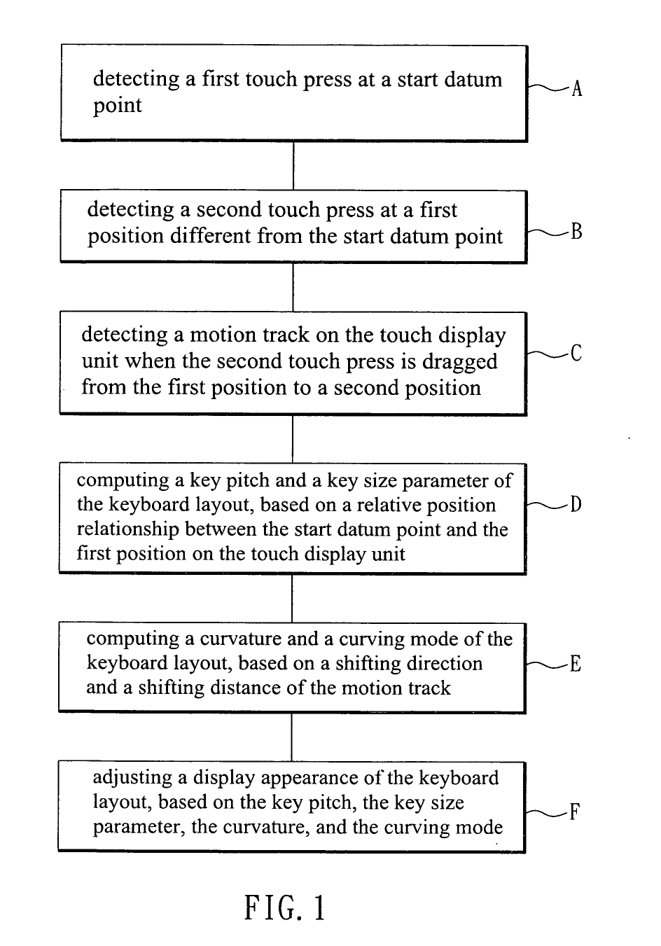

FIG. 1 is a flowchart of a method for adjusting a display appearance of a keyboard layout according to an embodiment of the invention. As shown in FIG. 1, the method includes the steps of:

(A) detecting a first touch press at a start datum point of a touch display unit;

(B) detecting a second touch press at a first position different from the start datum point;

(C) detecting a motion track on the touch display unit when the second touch press is dragged from the first position to a second position;

(D) computing a key pitch and a key size parameter of the keyboard layout, based on a relative position relationship between the start datum point and the first position;

(E) computing a curvature and a curving mode of the keyboard layout based on a shifting direction and a shifting distance of the motion track; and

(F) adjusting a display appearance of the keyboard layout, based on the key pitch, the key size parameter, the curvature, and the curving mode.

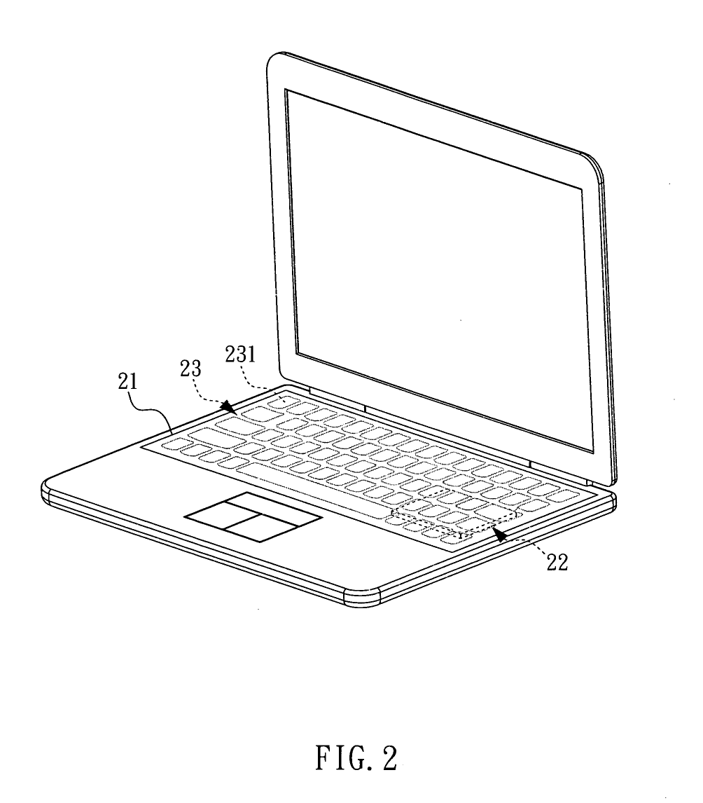

In addition, the keyboard layout is displayed on the touch display unit included in a computer shown in FIG. 2. As shown in FIG. 2, the computer includes the touch display unit 21 and a processing unit 22. The method can adjust a display appearance, such as the size and curvature form of the keyboard layout 23 on the touch display unit 21. The keyboard layout 23 has a plurality of key units 231.

It is noted that the keyboard layout 23 shown in FIG. 2 is only for describing the position of the keyboard layout 23 to be displayed, rather than for limiting the keyboard layout 23 to the actually displayed size. The keyboard layout 23 has a curvature form, such as an arch profile, in actual display for providing an ergonomic keyboard layout meeting with user requirements. In this embodiment, the touch display unit 21 is a capacitive touch display screen. Alternatively, the touch display unit 21 can be a resistive touch display screen.

Next, the method for adjusting a display appearance of the keyboard layout according to the present invention is described in detailed operation with reference to the drawings.

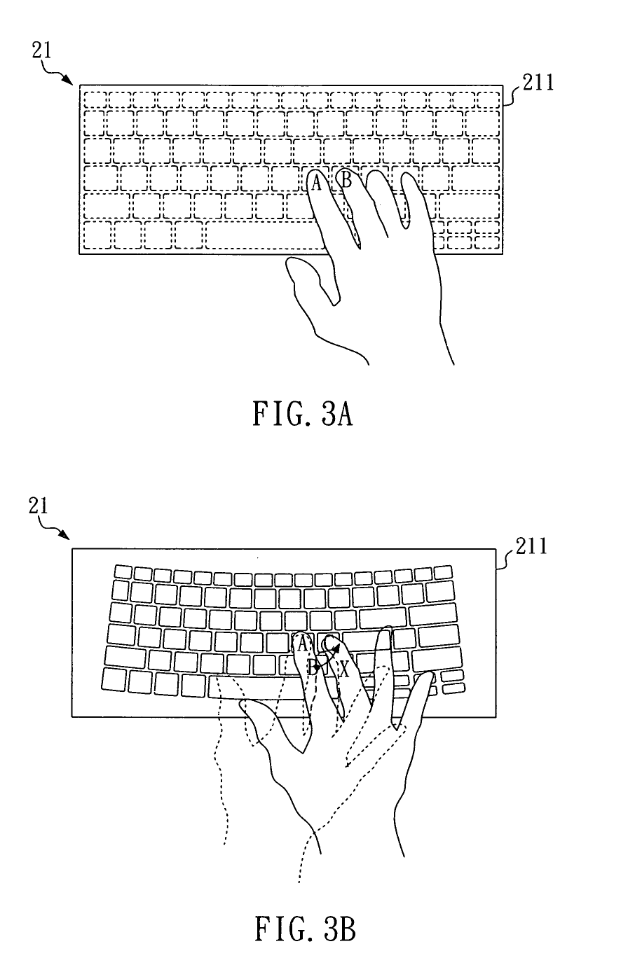

As shown in FIG. 3A, a user (not shown) uses the index finger of the right hand to press at a start datum point “A” of the touch display unit 21, and the processing unit 22 detects a first touch press at the start datum point “A” (step A). The user (not shown) then uses the middle finger of the right hand to press a first position “B” different from the start datum point “A”, and the processing unit 22 detects a second touch press at the first position (step B). Next, as shown in FIG. 3B, after the user (not shown) uses the middle finger of the right hand to press at the first position “B” of the touch display unit 21 (at this moment the index finger of the right hand maintains the press at the start datum point “A”), the second touch press is dragged from the first position “B” to a second position “C” to thus obtain a motion track “X”, and the processing unit 22 detects the motion track “X” on the touch display unit (step C).

After the processing unit 22 completely detects the first touch press, the second touch press, and the motion track “X”, it computes a key pitch and key size parameter of the keyboard layout 23 based on a relative position relationship between the start datum point “A” and first position “B” of the touch display unit 21 (step D). The “key pitch” indicates a distance between the adjacent key units 231 of the keyboard layout 23 shown in FIG. 2. In addition, the “key size parameter” indicates the amplification factor required for enlarging the plurality of key units 231 to be displayed on the touch display unit 21.

As shown in FIG. 3A, in this embodiment, the touch display unit 21 has a display area 211. When the processing unit 22 computes the “key pitch” and the “key size parameter”, a size of the display area 211 is also computed, in addition to the relative position relationship between the start datum point “A” and first position “B” of the touch display unit 21, thereby displaying an appropriate size of the keyboard layout 23 on the touch display unit 21.

After the processing unit 22 computes the “key pitch” and the “key size parameter”, it computes a curvature and curving mode of the keyboard layout 23 based on a shifting direction and a shifting distance of the motion track “X” (step E). The “curving mode” is a curve arrangement of the keyboard layout 23, such as an arch arrangement shown in FIG. 3B. The “curvature” indicates the curve degree of the keyboard layout 23 as displayed on the touch display unit 21. In this embodiment, the shifting direction of the motion track “X” is toward an upper right direction. Finally, the processing unit 22 adjusts a display appearance of the keyboard layout 23 displayed on the touch display unit 21, based on the “key pitch”, the “key size parameter”, the “curvature”, and the “curving mode” (step F). In this embodiment, the keyboard layout 23 is not displayed on the touch display unit 21 until the processing unit 22 completely computes the “key pitch”, the “key size parameter”, the “curvature”, and the “curving mode”. That is, in this embodiment, the keyboard layout 23 displayed by the touch display unit 21 has an arch form, and the size of the keyboard layout 23 corresponds to the size of the display area 211.

It is noted that in this case the curving mode of the keyboard layout 23 is shown an upward curving mode, but not limited to it. In other embodiments, the curving mode of the keyboard layout 23 can be a downward curving mode (when the shifting direction of the motion track “X” is toward a lower left direction).

It is noted that in this case the index and middle fingers of the right hand of a user are used to press at the start datum point and first position of the touch display unit respectively, but not limited to it. In other embodiments, a user can use the index and middle fingers of the left hand to press at the start datum point and first position of the touch display unit respectively, thereby adjusting a display appearance, such as the size and curvature form of the keyboard layout displayed on the touch display unit.

When a different user (not shown) subsequently uses the computer shown in FIG. 2, the processing unit 22 performs the method of the present invention again in order to display a keyboard layout 23 having a different size and curvature form, which meets with the use requirements of the different user. For example, when the different user is, a child, the finger lengths and the relative position between the fingers are relatively different from those of the previous user (parents). In this case, the computer shown in FIG. 2 can display a keyboard layout 23 with a smaller size and curvature on the touch display unit 21 for the different user.

When a third user (not shown) subsequently uses the computer shown in FIG. 2, the processing unit 22 performs the method of the present invention again in order to display a keyboard layout 23 having a different size and curvature form for meeting with the use requirements of the third user. For example, the third user has the habitually operating gestures just opposite to those of the immediately previous user, i.e., a keyboard layout with a downward curving mode is preferred. In this case, the computer shown in FIG. 2 can display a keyboard layout 23 with a downward curving mode on the touch display unit 21 for the third user.

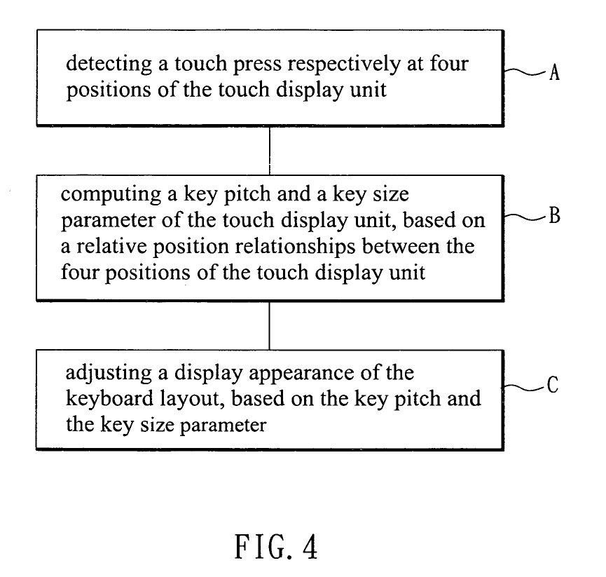

FIG. 4 is a flowchart of a method for adjusting a display appearance of a keyboard layout according to another embodiment of the invention. As shown in FIG. 4, the method includes the steps of:

(A) detecting a touch press respectively at four positions of the touch display unit;

(B) computing a key pitch and key size parameter of the touch display unit based on a relative position relationships between the four positions of the touch display unit; and

(C) adjusting a display appearance of the keyboard layout based on the key pitch and the key size parameter.

In addition, the keyboard layout is displayed on the touch display unit included in a computer shown in FIG. 2. As shown in FIG. 2, the computer includes the touch display unit 21 and a processing unit 22. The method can adjust a display appearance, such as the size of the keyboard layout 23 on the touch display unit 21. The keyboard layout 23 has a plurality of key units 231.

It is noted that the keyboard layout 23 shown in FIG. 2 is only for describing the position of the keyboard layout 23 to be displayed, rather than for limiting the keyboard layout 23 to the actually displayed size.

Besides, in this embodiment, the touch display unit 21 is a capacitive touch display screen. However, in other embodiments, the touch display unit 21 can be a resistive touch display screen.

Next, the method for adjusting a display appearance of a keyboard layout according to another embodiment of the invention is described in detailed operation with reference to the drawings.

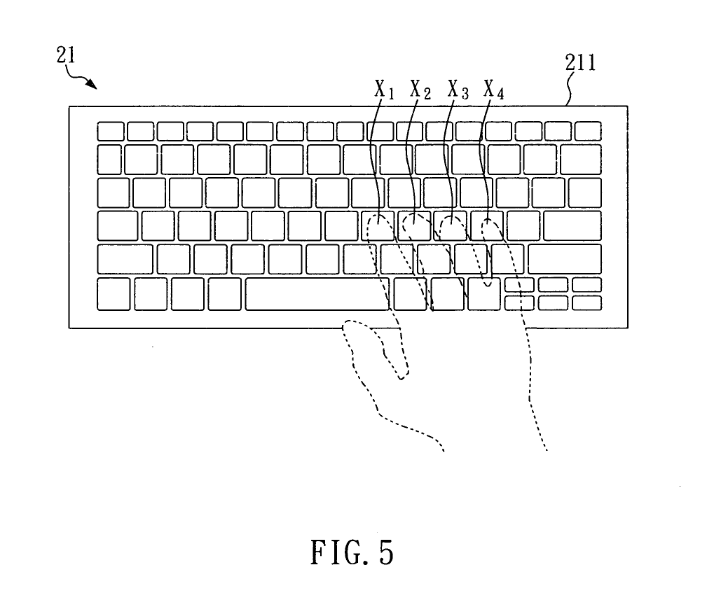

As shown in FIG. 5, a user (not shown) uses the index, middle, ring, and little fingers of the right hand to press at four positions “X₁”, “X₂”, “X₃”, and “X₄” on the touch display unit 21, and the processing unit 22 detects a touch press respectively at the four positions “X₁”, “X₂”, “X₃”, and “X₄” (step A). The processing unit 22 is then based on a relative position relationship between the four positions “X₁”, “X₂”, “X₃”, and “X₄” to compute a key pitch and key size parameter (step B). The “key pitch” indicates a distance between the adjacent key units 231 of the keyboard layout 23 shown in FIG. 2. In addition, the “key size parameter” indicates the amplification factor required for enlarging the plurality of key units 231 to be displayed on the touch display unit 21.

As shown in FIG. 5, in this embodiment, the touch display unit 21 has a display area 211, and when the processing unit 22 computes the “key pitch” and the “key size parameter”, a size of the display area 211 is also computed, in addition to the relative position relationship between the four positions “X₁”, “X₂”, “X₃”, and “X₄” on the touch display unit 21, thereby displaying an appropriate size of the keyboard layout 23 on the touch display unit 21.

Finally, the processing unit 22 adjusts a display appearance of the keyboard layout 23 displayed on the touch display unit 21, based on the “key pitch” and the “key size parameter” previously computed (step C).

It is noted that in this case the four fingers (index, middle, ring, little) of the right hand of the user are used to press at the four positions of the touch display unit, but not limited to it. In other embodiments, a user can use the four fingers (index, middle, ring, little) of the left hand to press at the four positions of the touch display unit, thereby adjusting a display appearance, such as the size of the keyboard layout displayed on the touch display unit.

When a different user (not shown) subsequently uses the computer shown in FIG. 2, the processing unit 22 performs the method of the present invention again in order to display a keyboard layout 23 having a different size, which meets with the use requirements of the different user. For example, when the different user is a child, the finger lengths and the relative position between the fingers are relatively different from those of the previous user (parents). In this case, the computer shown in FIG. 2 can display a keyboard layout 23 with a smaller size and curvature on the touch display unit 21 for the different user.

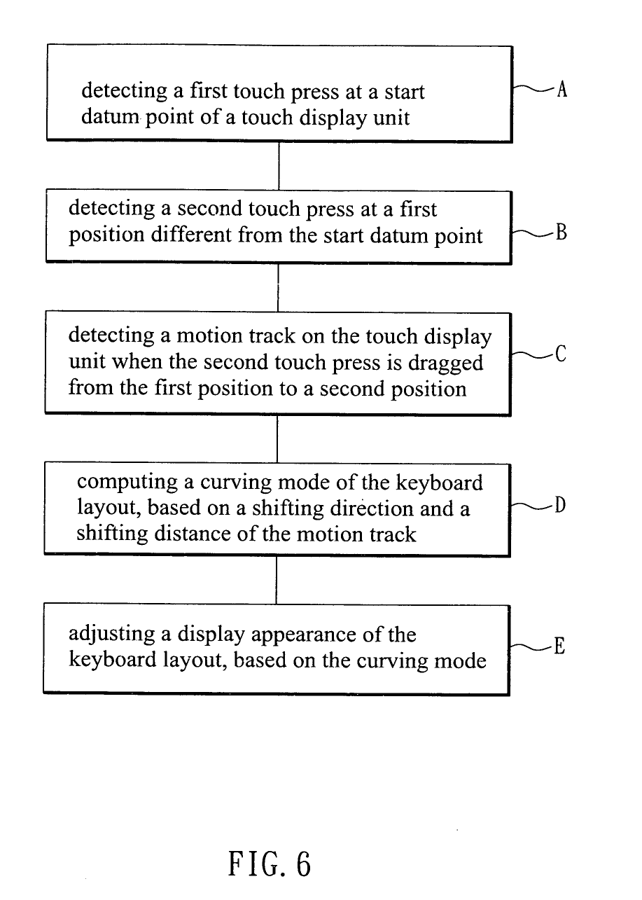

FIG. 6 is a flowchart of a method for adjusting a display appearance of a keyboard layout according to a further embodiment of the invention. As shown in FIG. 6, the method includes the steps of

(A) detecting a first touch press at the start datum point of the touch display unit;

(B) detecting a second touch press at a first position different from the start datum point;

(C) detecting a motion track on the touch display unit when the second touch press is dragged from the first position to a second position;

(D) computing a curving mode of the keyboard layout based on a shifting direction and distance of the motion track; and

(E) adjusting a display appearance of the keyboard layout based on the curving mode.

In addition, the keyboard layout is displayed on the touch display unit included in a computer shown in FIG. 2. As shown in FIG. 2, the computer includes the touch display unit 21 and a processing unit 22. The method can adjust a display appearance, such as the size and curvature form of the keyboard layout 23 on the touch display unit 21. The keyboard layout 23 has a plurality of key units 231.

Next, the method for adjusting a display appearance of the keyboard layout is described in detailed operation with reference to the drawings.

As shown in FIG. 3A, a user (not shown) uses the index finger of the right hand to press at a start datum point “A” of the touch display unit 21, and the processing unit 22 detects a first touch press at the start datum point

“A” (step A). Next, the user (not shown) uses the middle finger of the right hand to press at a first position “B” different from the start datum point “A”, and the processing unit 22 detects a second touch press at the first position (step B). As shown in FIG. 3B, after the user (not shown) uses the middle finger of the right hand to press at the first position “B” of the touch display unit 21 (at this moment the index finger of the right hand maintains the press at the start datum point “A”), the second touch press is dragged from the first position “B” to a second position “C” to thus obtain a motion track “X”, and the processing unit detects the motion track “X” on the touch display unit (step C).

After the processing unit 22 detects the first touch press, the second touch press, and the motion track “X” completely, it computes a curving mode and curvature of the keyboard layout 23 based on a shifting direction and distance of the motion track “X” (step D). The “curving mode” is a curve arrangement of the keyboard layout 23, such as an arch arrangement shown in FIG. 3B. The “curvature” indicates the curve degree of the keyboard layout 23 as displayed on the touch display unit 21. In this embodiment, the shifting direction of the motion track “X” is toward an upper right direction.

Finally, the processing unit 22 adjusts a display appearance of the keyboard layout 23 displayed on the touch display unit 21, based on the “curvature” and the “curving mode” (step E).

It is noted that in this case the curving mode of the keyboard layout 23 is shown an upward curving mode, but not limited to it. In other embodiments, the curving mode of the keyboard layout 23 can be a downward curving mode (when the shifting direction of the motion track “X” is toward a lower left direction.). In addition, in this case, the index and middle fingers of the right hand of a user are used to press at the start datum point and first position of the touch display unit respectively, but not limited to it. In other embodiments, a user can use the index and middle fingers of the left hand to press at the start datum point and first position of the touch display unit respectively, thereby adjusting a display appearance, such as the size and curvature form of the keyboard layout displayed on the touch display unit.

When a different user (not shown) subsequently uses the computer shown in FIG. 2, the processing unit 22 performs the method of the present invention again in order to display a keyboard layout 23 having a different size and curvature form, which meets with the use requirements of the different user. For example, the different user has the habitually operating gestures just opposite to those of the immediately previous user, i.e., a keyboard layout with a downward curving mode is preferred. In this case, the computer shown in FIG. 2 can display a keyboard layout 23 with a downward curving mode on the touch display unit 21 for the different user.

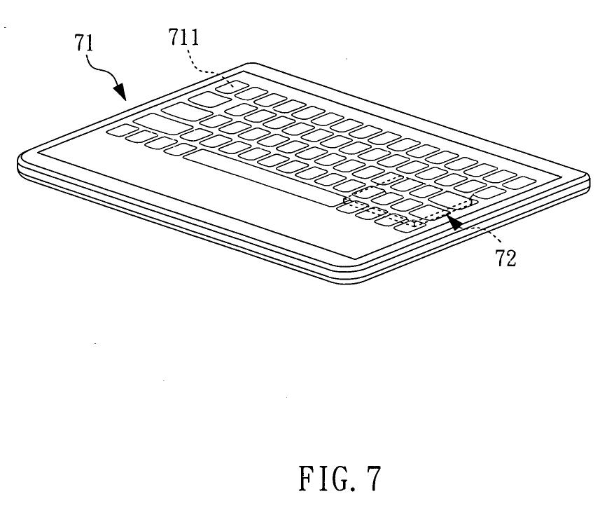

FIG. 7 is a flowchart of a keyboard with adjustable display appearance according to another embodiment of the invention. As shown in FIG. 7, the keyboard includes a touch display unit 71 and a processing unit 72 coupled to the touch display unit 71. The touch display unit 71 has a plurality of key units 711. The processing unit 72 detects a motion track (not shown) of a user on the touch display unit 71 and adjusts a display appearance of the plurality of key units 711 based on the motion track. In this embodiment, the touch display unit 71 is a capacitive touch display screen. In other embodiments, the touch display unit 71 can be a resistive touch display screen.

In addition, when the keyboard according to this embodiment of the invention is operated, the processing unit 72 can perform either one of the methods stated above to detect a motion track (e.g., the motion track “X” shown in FIG. 3B) on the touch display unit 71 when a user moves the fingers on the touch display unit, thereby adjusting the display appearance of the plurality of key units 71 (for example, a size, key pitch, curvature, and curving mode of the key units).

All the embodiments of the invention are shown in detail to cite the steps above, so that no more description herein is taken.

As stated above, the invention uses a processing unit of a keyboard with adjustable display appearance to detect a motion track, thereby computing the “key pitch”, “key size parameter”, “curvature”, and “curving mode” of a plurality of key units of the touch display unit. Therefore, the keyboard of the invention can adaptively adjust the display appearance of the key units of the touch display unit.

Although the present invention has been explained in relation to its preferred embodiment, it is to be understood that many other possible modifications and variations can be made without departing from the spirit and scope of the invention as hereinafter claimed.

What is claimed is:

1. A method for adjusting a display appearance of a keyboard layout displayed on a touch display unit, the keyboard layout having a plurality of key units, the touch display unit having a start datum point, the method comprising the steps of:
(A) detecting a first touch press at the start datum point;
(B) detecting a second touch press at a first position different from the start datum point;
(C) detecting a motion track on the touch display unit when the second touch press is dragged from the first position to a second position;
(D) computing a key pitch and a key size parameter of the keyboard layout, based on a relative position relationship between the start datum point and the first position on the touch display unit;
(E) computing a curvature and a curving mode of the keyboard layout, based on a shifting direction and a shifting distance of the motion track; and
(F) adjusting a display appearance of the keyboard layout, based on the key pitch, the key size parameter, the curvature, and the curving mode.

2. The method as claimed in claim 1, wherein the touch display unit comprises a display area, and the key pitch and the key size parameter are computed based on the relative position relationship between the start datum point and the first position on the touch display unit, with a size of the display area.

3. The method as claimed in claim 1, wherein the curving mode is an upward or downward curving mode.

4. The method as claimed in claim 1, wherein the touch display unit is a capacitive touch display screen or a resistive touch display screen.

5. The method as claimed in claim 1, wherein the first touch press is obtained by using an index finger of a user to press on the touch display unit.

6. The method as claimed in claim 5, wherein the second touch press is obtained by a middle finger of the user to press on the touch display unit.

7. A method for adjusting a display appearance of a keyboard layout displayed on a touch display unit, the keyboard layout having a plurality of key units, the method comprising the steps of:
(A) detecting a touch press respectively at four positions of the touch display unit;
(B) computing a key pitch and a key size parameter of the touch display unit based on a relative position relationships between the four positions of the touch display unit; and
(C) adjusting a display appearance of the keyboard layout based on the key pitch and the key size parameter.

8. The method as claimed in claim 7, wherein the touch display unit comprises a display area, and the key pitch and the key size parameter are computed based on the relative position relationship between the four positions of the touch display unit, with a size of the display area.

9. The method as claimed in claim 7, wherein the four touch presses are obtained by index, middle, ring, little fingers of a user to press on the touch display unit.

10. A method for adjusting a display appearance of a keyboard layout displayed on a touch display unit, the keyboard layout having a plurality of key units, the method comprising the steps of:
(A) detecting a first touch press on the touch display unit;
(B) detecting a second touch press on the touch display unit different from the first touch press;
(C) detecting a motion track on the touch display unit when the second touch press is dragged;
(D) computing a key pitch and a key size parameter of the keyboard layout, based on a relative position relationship between the first touch press and the second touch press on the touch display unit; and
(E) adjusting a display appearance of the keyboard layout based on the key pitch, the key size parameter and the motion track.

11. A keyboard with adjustable display appearance, comprising:
a touch display unit having a plurality of key units; and
a processing unit coupled to the touch display unit in order to detect a motion track on the touch display unit from a user and to adjust a display appearance of the key units based on the motion track.
